(19) United States
(12) Patent Application Publication
(10) Pub. No.: US 2025/0098591 A1
(43) Pub. Date: Mar. 27, 2025

(54) Weed Prevention System for a Combine Harvester

(71) Applicant: AGCO do Brasil Soluções Agrícolas Ltda., Ribeirao Preto (BR)

(72) Inventor: Marcelo Carpenedo, Sapucaia do Sul (BR)

(21) Appl. No.: 18/883,779

(22) Filed: Sep. 12, 2024

(30) Foreign Application Priority Data
Sep. 26, 2023 (GB) 2314748.1

(51) Int. Cl. A01D 41/12

(52) U.S. Cl. CPC A01F 12/40; A01D 41/1243

(57) ABSTRACT

A weed prevention unit for a combine harvester has a rotary mill for receiving material from a grain cleaning system of the combine harvester, and distributing the material. An outer housing comprises an inlet at one end of an internal rotor along an axis of rotation and an outlet at an opposite end of the internal rotor along the axis of rotation. The internal rotor comprises a central hub and stacks of hammers extending radially outwardly from the central hub, each stack aligned in the direction of the axis of rotation. The outer housing comprises one or more chambers extending radially outwardly from an otherwise cylindrical general form. The outer housing may also comprise inwardly facing guide vanes, each comprising a portion of a spiral shape extending between the inlet and outlet.

### FIELD

Embodiments of the present disclosure relate generally to combine harvesters, and in particular to a weed prevention system used within a combine harvester.

### BACKGROUND

A combine harvester typically includes a threshing system for detaching grains of cereal from material other than grain, such as cobs, stems and seed pods, a separating apparatus downstream of the threshing system, and a grain cleaning apparatus (known as the cleaning shoe) for receiving grain from the separating apparatus. A stratification pan aims to stratify the material into a layered structure of grain at the bottom and light chaff and other material other than grain (MOG) at the top. The grain is collected in a grain bin, and from the grain bin the grain can be unloaded, for example to a trailer pulled by a tractor which runs alongside the combine harvester.

Weed control is a worldwide problem in agriculture and requires a large investment to prevent food production being affected. Weeds can take over a field and prevent food growth (soybean, wheat, oat, corn, etc.) at a sustainable level. Weeds can arise as part of the natural environment, if the weed variety was present before agricultural processes, or weeds can be introduced intentionally, e.g., grasses from other regions with high level of mass production for livestock, or unintentionally e.g., as seed contamination from other regions. The fact is that weeds are a very relevant problem with which farmers need to deal every day.

A most common way to control weeds is by chemicals application. Increasingly, the negative impacts on the environment are of concern to customers and authorities alike. Manual weed control is impracticable for large scale production. Weed control by steam application is also currently used but not on a large scale.

This disclosure relates to another approach, by which weed growth is controlled by damaging seeds collected by a combine harvester, before they are returned to a field as residue. This is a weed prevention approach in the sense that it seeks to limit the growth of weeds rather than removing weeds after they have grown. A weed prevention system may for example be coupled to the combine harvester as part of the residue management system. It is used to process weed seeds from the harvesting process and impart mechanical damage to the seeds in order to prevent germination. Although the concept is simple, there are many technical hurdles to make a system suitable for integration into the residue management process of a combine harvester.

One known weed seed controlling system is named the SCU—Seed Control Unit. It has a pair of rotors replacing the current chaff spreader system of a combine harvester. The unit forces the seeds to move inside a mill structure, hitting a group of obstacles. Each impact causes mechanical damage to the seed, preventing it from germinating. Examples are disclosed in U.S. Pat. Nos. 5,232,405 and 5,482,508.

The known approaches apply a limited amount of damage to the seeds. There is a need for an improved effectiveness of the system.

### BRIEF SUMMARY

According to examples in accordance with the invention, there is provided a weed prevention unit for a combine harvester, having a rotary mill for receiving material from a grain cleaning system of the combine harvester, and distributing the material, wherein the rotary mill comprises an outer housing and an internal rotor with an axis of rotation. The outer housing includes an inlet at one end of the internal rotor along the axis of rotation, the inlet flow being generally along the direction of the axis of rotation, and an outlet at an opposite end of the internal rotor along the axis of rotation, the outlet flow being generally radially outwardly from the axis of rotation. The internal rotor includes a central hub along the axis of rotation and at least two stacks of hammers extending radially outwardly from the central hub, each stack aligned in the direction of the axis of rotation. The outer housing includes one or more chambers extending radially outwardly.

This weed prevention unit aims to damage seeds present in the material delivered by a combine harvester cleaning shoe. The material is received from above by a rotary mill, and hence from an inlet formed as the end face of a generally cylindrical mill. The outlet is at the bottom, and is an opening to allow a radial outlet flow. Hammers strike the material on its passage from the inlet to the outlet. The material thus follows a path down the mill (i.e., with a component of movement along the direction of the axis of rotation). In this way, the material is subjected to multiple passes of the hammers in each stack, thus creating a more effective seed damage approach. The chambers extend radially outwardly from a generally cylindrical form of the outer housing, and they receive material by centrifugal forces. They are designed to impart further damage to seeds within the material.

The outer housing for example comprises inwardly facing guide vanes, each comprising a portion of a spiral shape extending between the inlet and outlet. These guide vanes on the inner surface direct the flow of material to follow a spiral path down the mill, hence being struck multiple times by the hammers. This further assists the effective destruction of seeds within the material.

The outer housing for example forms a continuous cylinder at the one end, with the inlet extending along the axis of rotation, and the outer housing forms a cylinder with an opening around its circumference at the other end, the opening defining the outlet. Thus, there is a section of the housing along which the material passes while being trapped within the mill.

The chamber or chambers for example have a sloped entrance surface for guiding material into the chamber and a step to an exit surface for impacting the material when it exits the chamber.

The sloped entrance surface for example has an angle with respect to the local tangent of less than 20 degrees so that material is smoothly guided into the chamber. The step of the exit surface is an internal angle for example of less than 135 degrees (e.g,. 90 degrees), so forcing an abrupt change in direction of the seeds and presenting a step wall against which the seeds are driven.

The unit for example comprises four chambers, preferably equally spaced around the circumference of the outer wall. The unit for example comprises four stacks of hammers, preferably equally spaced around the central hub.

The top hammer of each stack may comprise a sloped upper face, sloping with a component in the direction of the rotation axis. This is used to guide material from the inlet in a general direction towards the outlet. The unit is for example pivotally mounted to a combine harvester chassis. This enables the unit to be moved to a suitable position for cleaning or repair or maintenance.

The disclosure also provides a weed prevention system comprising first and second weed prevention units, each as defined above. The units are for example side by side, with opposing directions of rotation of their rotors.

The disclosure also provides a combine harvester having a crop cutting head, a threshing and separating system, a grain cleaning system for receiving the cut and threshed crop material, and the weed prevention system as defined above downstream of the grain cleaning system.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with the invention;

FIG. 2 shows one example of threshing system and grain cleaning apparatus in more detail;

FIG. 3 shows a weed prevention system from above;

FIG. 4 shows the weed prevention system from below;

FIG. 5 shows one of the mills from above;

FIG. 6 shows the same view as FIG. 5 with an upper cover removed so that the internal components can be seen more clearly;

FIGS. 7 and 8 show the internal design of the outer housing more clearly;

FIG. 9 shows the system from above, with arrows to show the general flow direction through the mill; and

FIG. 10 shows the system from the side and also with arrows to show the direction of flow.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure provides a weed prevention unit for a combine harvester having a rotary mill for receiving material from a grain cleaning system of the combine harvester, and distributing the material. An outer housing comprises an inlet at one end of an internal rotor along an axis of rotation and an outlet at an opposite end of the internal rotor along the axis of rotation. The internal rotor comprises a central hub and stacks of hammers extending radially outwardly from the central hub, each stack aligned in the direction of the axis of rotation. The outer housing comprises one or more chambers extending radially outwardly from an otherwise cylindrical general form. The outer housing may also comprise inwardly facing guide vanes, each comprising a portion of a spiral shape extending between the inlet and outlet.

This disclosure relates to the design of a weed control system to be implemented by a combine harvester. However, a general outline of a combine harvester will first be provided.

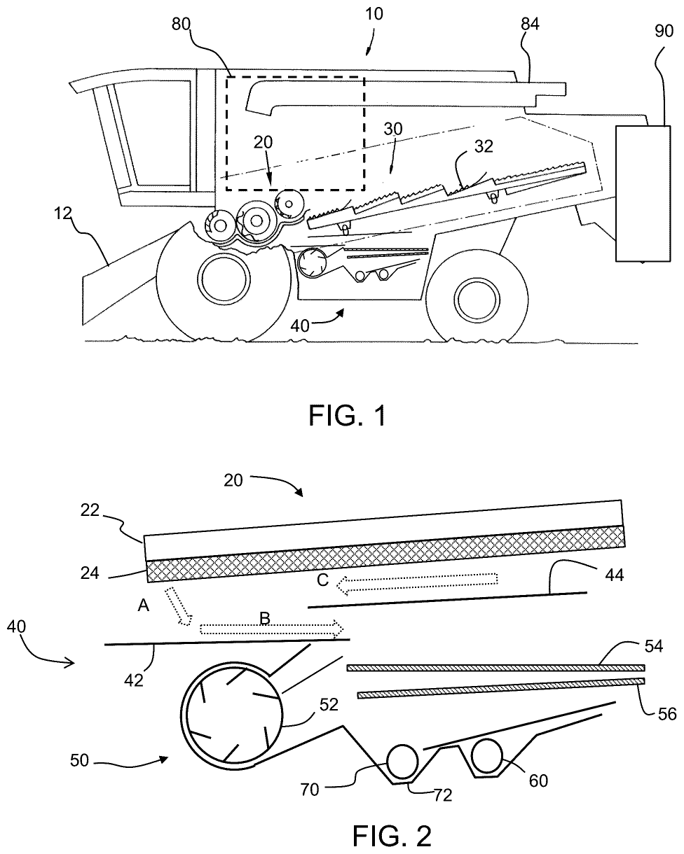

FIG. 1 shows a first example of a known combine harvester 10 to which the invention may be applied. The combine harvester includes a threshing system 20 for detaching grains of cereal from the ears of cereal, and a separating apparatus 30 which is connected downstream of the threshing system 20. The threshing system comprises one or more threshing units, in particular rotors, and associated concaves. In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The grain cleaned by the grain cleaning apparatus is delivered to a grain bin 80 by a filling auger 70. Grain from the grain bin is removed from the combine harvester by an unloading tube 84.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing system 20.

In the example shown, the threshing system 20 is a tangential-flow ‘conventional’ threshing system, i.e., formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e., formed by rotating elements with an axis of rotation in the longitudinal direction (direction of travel). For example, the threshing section may have axially-aligned rasp bars spaced around the front section whilst the separating section has separating elements or fingers arranged in a pattern, e.g., a spiral pattern, extending from the rasp bars to the rear of the rotor.

The MOG (material other than grain), in particular chaff, exits the combine harvester at the back. A chaff spreader 90 is provided at the back of the combine harvester. The chaff spreader may be used for spreading the chaff in a uniform layer over the harvested field.

As mentioned above, instead of tangential flow threshing (and separating), axial threshing (and separating) is also known, and the invention may be applied to any type of combine. For completeness, FIG. 2 shows an axial threshing and separating system 20, together with a more detailed view of the cleaning apparatus 40.

The threshing system 20 in this case comprises an axial rotor 22 beneath which is mounted the concave 24. The concave may have different sections along its length, and the first section to receive the crop material (to the left in FIG. 2) may have a releasable concave, or else the whole length of the concave may be releasable. The separating function for this type of combine involves conveying the crop stream rearwardly in a ribbon passing along a spiral path.

No matter what type of threshing is performed, the initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the bin.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the more dense grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to the on-board bin by the filling auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain is for example smaller and denser and generally more aerodynamic than MOG, therefore, less susceptible to being conveyed rearward by the chaffer/sieve and/or blown out of the rear of the machine by the air stream of the cleaning fan, passing upward and rearward, through the chaffer.

Most of the material which has not been collected by the filling auger 70 or returns auger exits the back of the combine harvester and passes to the chaff spreader 90. Thus, the chaff spreader is downstream of the threshing and separating apparatus and also receives the rejected material from the cleaning shoe.

This disclosure relates to a design of a weed prevention system. It may for example receive material from the cleaning shoe of the combine harvester, and may thus be used in place of a chaff spreader. It may perform the same function as a conventional chaff spreader (i.e. distributing the material over the field) but additionally perform a function of damaging unwanted seeds. In another configuration, a weed prevention system and a chaff spreader may be used in combination.

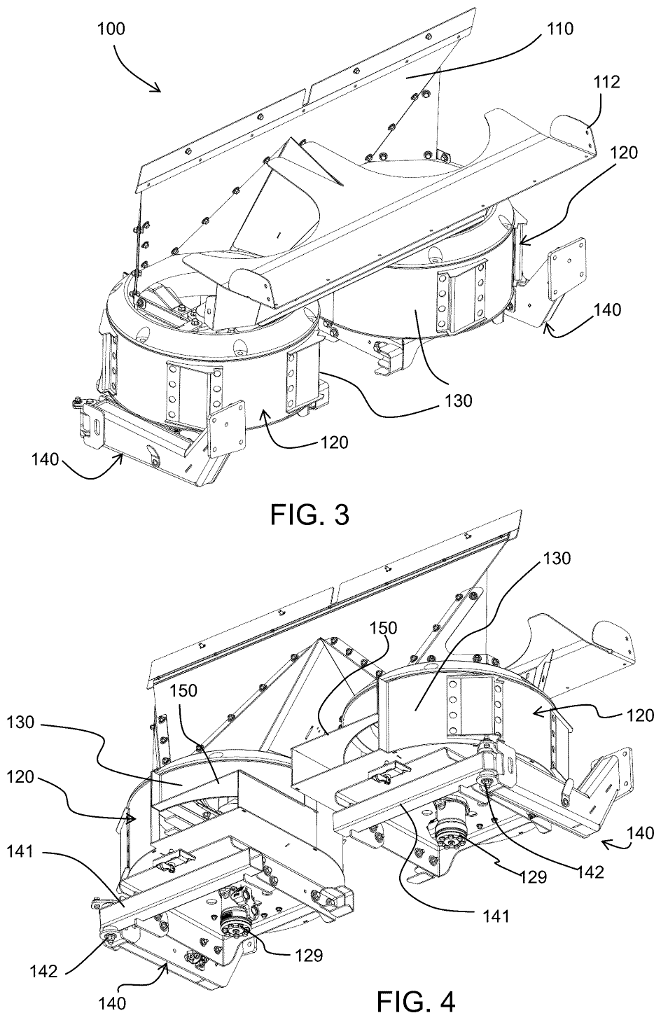

FIG. 3 shows a weed prevention system 100 from above. As explained above, it is for example intended to be mounted in the conventional location of a chaff spreader, namely to receive material from the cleaning system of a combine harvester. Thus, it is fed by the chaff and seeds coming from the cleaning system. The weed prevention system 100 has a pair of rotating mills 120 each comprising an outer housing 130. The outer housings are generally cylindrical with an internal rotor. The cylinders are arranged upright, with an inlet opening at the top, thus in (or defining) a top end face of the cylinder. The outer housings are connected to a chassis 140. Material is fed into the system from above, so that an inlet flow into the mills is generally along the direction of the rotation axis of the mills. Each mill has a rear deflector 110 and a funnel arrangement 112. Together, they redirect a flow from the cleaning apparatus into a generally downward direction into the mills,

FIG. 4 shows the weed prevention system 100 from below. It shows that the outer housings each have a discharge port 150 at the bottom of each mill, from which the residue is spread over the field. The outlet flow is thus generally radial in that the outlet is in at the bottom of a side wall of the generally cylindrical outer housing. The mills are driven by a rotary input shaft 129.

Each of the mills is mounted to the chassis 140, in particular to chassis arms 141 which are pivoted to the rest of the chassis about a connection point 142. This enables the system to be opened to enable machine internal maintenance or inspection.

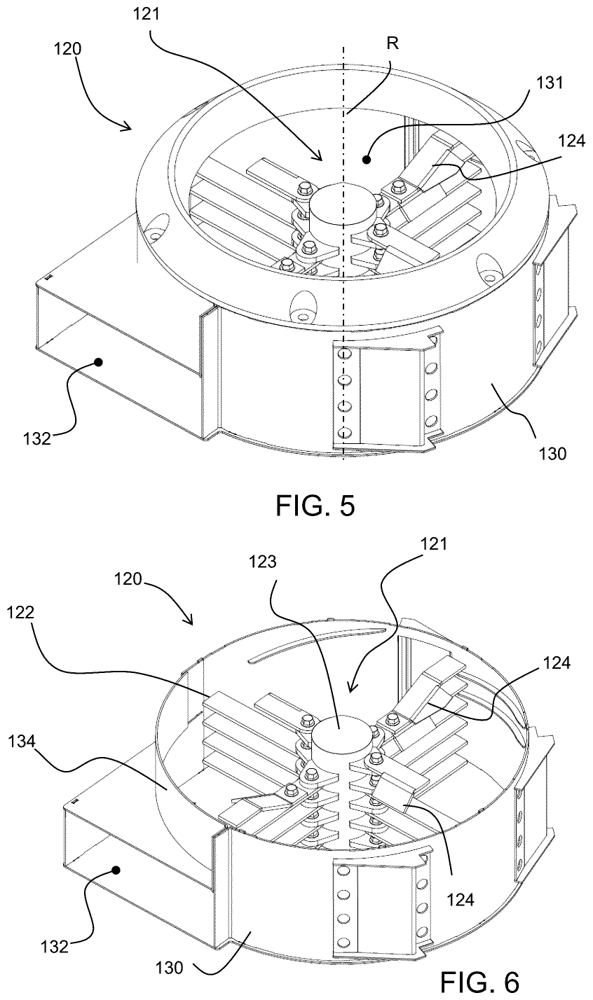

FIG. 5 shows one of the mills 120 from above and FIG. 6 shows the same view with an upper cover removed so that the internal components can be seen more clearly. The rotor housing 130 comprises an inlet area 131 and an outlet area 132 (defined by the discharge port 150). The mill 120 comprises a rotor 121 within the outer housing 130. The rotor rotates about an axis of rotation R. A group of hammers 122 extends radially outwardly from a central hub 123 of the rotor. The uppermost hammers 122 are the first to receive the material flow from the inlet area 131 and they include sloped ribs 124 to direct the the material flow to enter the mill. The top of the central hub 123 has a domed surface to prevent material accumulation.

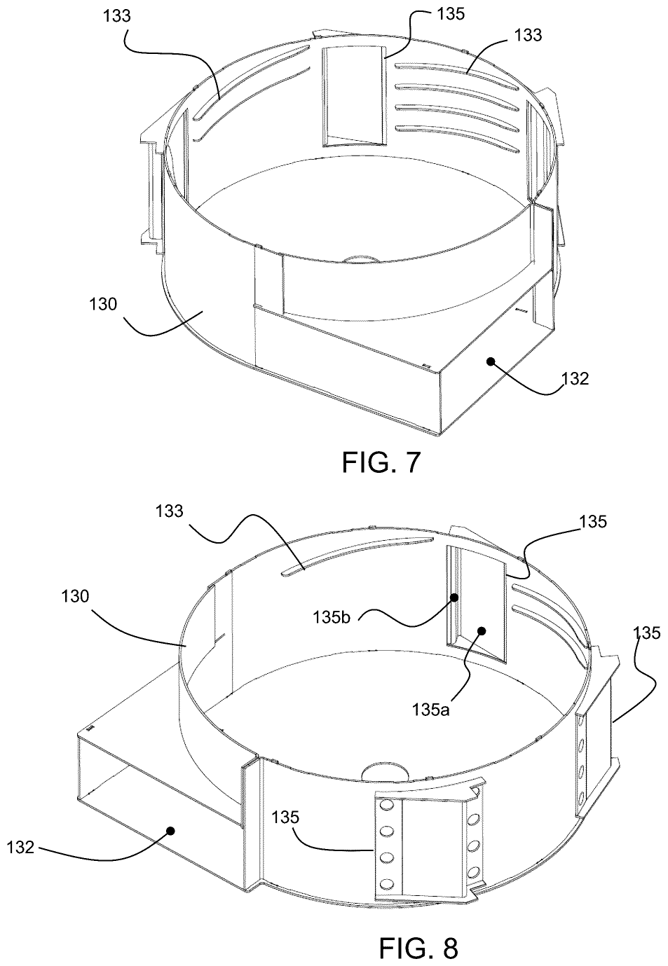

FIGS. 7 and 8 show the internal design of the outer housing 130 more clearly, with the rotors removed. The outer housing 130 defines the inlet area 131 and the outlet area 132. The internal surface of the outer housing 130 has raised (i.e., radially inwardly projecting) guide vanes 133 for encouraging material flow from the inlet area 131 to the outlet area 132.

The outlet area 132 is formed at the bottom of the outer housing 130, so that the circumference around the bottom of the housing is not closed, but has a gap which defines the outlet area 132. A top portion of the housing 130 has a closed circumferential section, where the material is not able to leave the mill, thereby forcing it to remain inside the mill, being guided downwardly by the guide vanes 133, for a sufficient time to result in a desired amount of damage to the seeds.

The guide vanes for example comprise portions of a spiral shape, spiraling down from the inlet area to the outlet area. These portions for example extend around an angle between 10 and 90 degrees. However, the guide vanes may instead form a continuous spiral although this may be more difficult to manufacture.

The outer housing 130 also comprises a set of material brakes 135. These comprise recesses into the outer wall of the housing (so having with an increased radius compared to the remainder of the cylindrical outer housing). They have a smooth transition to an inlet side 135a and an abrupt outlet side 135b. For example, the inlet side comprises a sloped flat entrance surface with an angle with respect to the local tangent of less than 20 degrees so that material is smoothly guided into the chamber. The outlet side is formed by a step with an internal angle for example of less than 135 degrees (e.g. 90 degrees), so forcing an abrupt change in direction of the seeds and presenting a step wall against which the seeds are driven.

Following the direction of flow imparted by the rotors, the material is urged to follow the slope of the smooth inlet side 135a and then strike the abrupt outlet side 135b, and be deflected back into the rotary flow inside the outer housing 130. The material brakes 135 thus create an obstruction to the material flow and this increases the damages to the seeds.

The outlet side 135b is shorter than the inlet side 135a. In the illustrated embodiment the ratio of the length of the inlet side 135a to the length of the outlet side 135b is approximately 3:1. Other ratios may also be implemented within the range 2:1 to 6:1. The greater this ratio, that is the “deeper” the material brake the greater proportion of weed seed impacting the outlet side 135b. However, this needs to be offset against the higher power consumption involved and the risk of plugging. Accordingly, the illustrated 3:1 ratio is preferred.

Only at the bottom portion of the outer housing 130 is the material flow able to exit the mill 120 and be spread over the field.

The rotors are driven by motors, for example hydraulic motors, but the drive system can be electric or mechanical. The housings 130 can be rotated into different angular orientations, so that the outlet area direction can be adjusted to change a direction of material spreading. The mills are for example rotated in opposite directions to change the spread angle of material. Thus, a material discharge angle on one side is accompanied by corresponding opposite discharge angle on the other side to maintain a symmetrical discharge of material.

The material may for example be spread to the rear or to lateral sides or to any position between. This is the normal chaff spreading function, so that the weed prevention system combines seed damage with chaff spreading. Instead, the weed prevention system may be designed only for imparting seed damage, and the outlet flow may be directed into a separate chaff spreader.

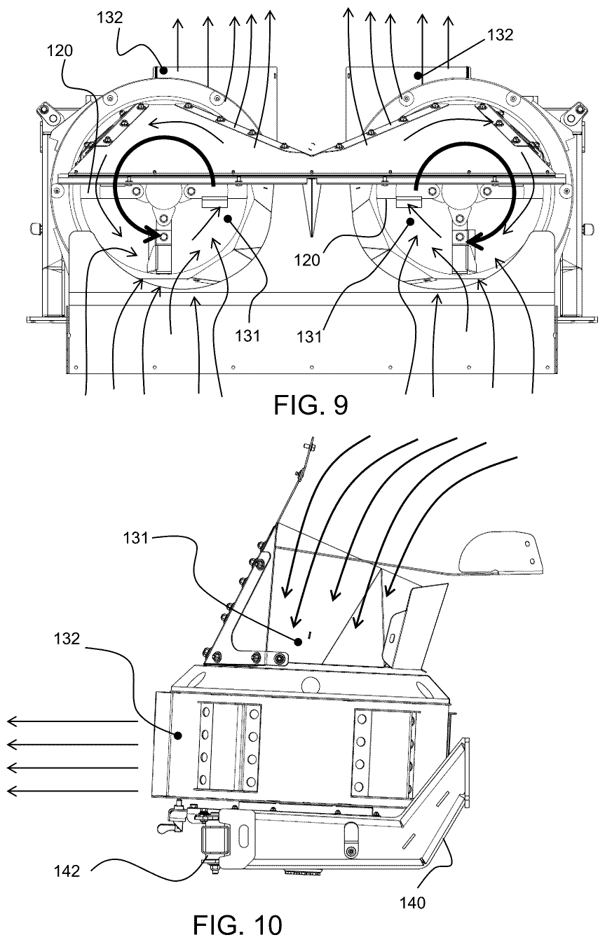

FIG. 9 shows the weed prevention system from above, with arrows to show the general flow direction through the weed prevention system. FIG. 10 shows the system from the side and also with arrows to show the direction of flow.

The system comprises two mills side by side, with opposing directions of rotation of their rotors. The material flow enters the mills from above, from the grain cleaning apparatus. The inlet flow is thus in a direction generally parallel to the axis of rotation as explained above. The exit flow is however radial, through the opening which discharge opening 150 that defines the outlet area 132.

The outer housings may be rotated by separate drive mechanisms, or a linkage may couples the two mills together, such that an angle adjustment of one mill entrains an opposite direction angle adjustment of the other mill, so that a single drive mechanism is used. An actuator is then used to adjust an angle at which chaff is ejected from the first and second mills.

The invention may be applied to any design of combine harvester. Thus, it does not rely on any particular threshing, separating or cleaning design, and the examples above are only given to aid overall understanding.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A weed prevention unit for a combine harvester, comprising:
a rotary mill for receiving material from a grain cleaning system of the combine harvester, and distributing the material, wherein the rotary mill comprises an outer housing and an internal rotor with an axis of rotation,
wherein the outer housing comprises an inlet at one end of the internal rotor along the axis of rotation, the inlet flow being generally along the direction of the axis of rotation, and an outlet at an opposite end of the internal rotor along the axis of rotation, the outlet flow being generally radially outwardly from the axis of rotation,
wherein the internal rotor comprises a central hub along the axis of rotation and at least two stacks of hammers extending radially outwardly from the central hub, each stack aligned in the direction of the axis of rotation,
wherein the outer housing comprises one or more chambers extending radially outwardly from an otherwise cylindrical general form.

2. The unit of claim 1, wherein the outer housing comprises inwardly facing guide vanes, each having a shape of a section of a spiral extending between the inlet and outlet.

3. The unit of claim 1, wherein the outer housing forms a continuous cylinder at the one end, with the inlet extending parallel to the axis of rotation, and the outer housing forms a cylinder with an opening around its circumference at the other end, the opening defining the outlet.

4. The unit of claim 1, wherein chamber or chambers have a sloped entrance surface define by an inlet side for guiding material into the chamber and a step to an exit surface defined by an outlet side for impacting the material when it exits the chamber.

5. The unit of claim 4, wherein the ratio of the length of the inlet side 135a to the length of the outlet side is within the range 2:1 to 6:1.

6. The unit of claim 4, wherein the ratio of the length of the inlet side 135a to the length of the outlet side is 3:1.

7. The unit of claim 1 comprising four chambers.

8. The unit of claim 1 comprising four stacks of hammers.

9. The unit of claim 1, wherein the top hammer of each stack comprises a sloped upper face, sloping with a component in the direction of the rotation axis.

10. The unit of claim 1, wherein the unit is pivotally mounted to a combine harvester chassis.

11. A weed prevention system comprising first and second weed prevention units, each as claimed in claim 1.

12. The weed prevention system of claim 11, wherein the units are side by side, with opposing directions of rotation of their rotors.

13. A combine harvester comprising:
a crop cutting head;
a threshing and separating system;
a grain cleaning system for receiving the cut and threshed crop material; and
the weed prevention system of claim 11 downstream of the grain cleaning system.
